(19) United States
(12) Patent Application Publication
(10) Pub. No.: US 2022/0390606 A1
(43) Pub. Date: Dec. 8, 2022

(54) VEHICLE-MOUNTED MEASUREMENT DEVICE UNIT AND INTEGRATED DATA GENERATION METHOD IN VEHICLE-MOUNTED MEASUREMENT DEVICE UNIT

(71) Applicant: DENSO CORPORATION, Kariya-city (JP)

(72) Inventor: Hirotaka MATSUO, Kariya-city (JP)

(21) Appl. No.: 17/820,146

(22) Filed: Aug. 16, 2022

Related U.S. Application Data
(63) Continuation of application No. PCT/JP2021/004614, filed on Feb. 8, 2021.

(30) Foreign Application Priority Data
Feb. 17, 2020 (JP) 2020-024168

(51) Int. Cl. G01S 17/87; G01S 17/86; G01S 17/931; G01S 17/89

(52) U.S. Cl. CPC G01S 17/87; G01S 17/86; G01S 17/931; G01S 17/89

(57) ABSTRACT

A vehicle-mounted measurement device unit includes a data processing device. The data processing device includes: a plurality of detector input units, each of which being connected to a corresponding one of a plurality of detectors having respective predetermined detection areas; an output unit configured to be connected to a vehicle control device arranged in a vehicle; an overlapping detection area setting unit configured to dynamically set an overlapping detection area between a plurality of arbitrary detectors among the plurality of detectors; and an integrated data generation unit configured to, in accordance with the set overlap detection area, generate integrated data using detection data corresponding to the detection areas input from the plurality of detectors via the plurality of detector input units and output the integrated data via the output unit.

### CROSS-REFERENCE TO RELATED APPLICATION

The present application is a continuation application of International Application No. PCT/JP2021/004614, filed on Feb. 8, 2021, which claims priority to Japanese Patent Application No. 2020-024168, filed on Feb. 17, 2020. The contents of these applications are incorporated herein by reference in their entirety.

### BACKGROUND

### Technical Field

The present disclosure relates to a measurement device unit that is mountable in a vehicle for use.

### Background Art

There have been proposed techniques for acquiring environmental information in all directions of a vehicle by a plurality of video cameras mounted to the vehicle.

### SUMMARY

In the present disclosure, provided is a vehicle-mounted measurement device unit as the following.

The vehicle-mounted measurement device unit includes a data processing device including: a plurality of input units; an output unit; an overlapping detection area setting unit configured to dynamically set an overlapping detection area between a plurality of arbitrary detectors among a plurality of detectors, for use during measurement and during non-measurement, or for use under normal conditions and under abnormal conditions; and an integrated data generation unit configured to, in accordance with the set overlap detection area, generate integrated data using detection data corresponding to detection areas input from the plurality of detectors via the plurality of input units and output the integrated data via the output unit.

### BRIEF DESCRIPTION OF THE DRAWINGS

The above-described and other objectives, features, and advantages of the present disclosure will become more clearly by the detailed description below with reference to the accompanying drawings. The drawings are as follows:

FIG. 1 is an explanatory diagram illustrating an example of a vehicle equipped with a measurement device unit according to a first embodiment;

FIG. 2 is an explanatory diagram illustrating a mode of connection of the measurement device unit according to the first embodiment to a vehicle control device;

FIG. 3 is a block diagram of a functional configuration of a data processing device according to the first embodiment;

FIG. 4 is a flowchart of an overlapping detection area setting process and an integrated data generation process executed by the data processing device according to the first embodiment;

FIG. 5 is an explanatory diagram schematically illustrating detection areas of detectors at during measurement;

FIG. 6 is an explanatory diagram schematically illustrating detection areas of the detectors during calibration or diagnosis;

FIG. 7 is an explanatory diagram schematically illustrating data acquired by the detectors;

FIG. 8 is an explanatory diagram illustrating an example of communication band allocations in the integrated data before and after change of the overlapping detection area;

FIG. 9 is an explanatory diagram schematically illustrating detection areas of the detectors under normal conditions;

FIG. 10 is an explanatory diagram schematically illustrating detection areas of the detectors under fault conditions;

FIG. 11 is a flowchart of an overlapping detection area setting process and an integrated data generation process executed by a data processing device according to a second embodiment;

FIG. 12 is an explanatory diagram schematically illustrating data acquired by detectors;

FIG. 13 is an explanatory diagram illustrating an example of communication band allocations in integrated data before and after change of the overlapping detection area;

FIG. 14 is an explanatory diagram schematically illustrating detection areas of the detectors under fault conditions;

FIG. 15 is an explanatory diagram illustrating an example of communication band allocations in the integrated data before and after change of the overlapping detection area;

FIG. 16 is an explanatory diagram illustrating a connection mode of a measurement device unit according to another embodiment;

FIG. 17 is an explanatory diagram illustrating an example in which a data processing device according to another embodiment is arranged in a vehicle;

FIG. 18 is an explanatory diagram illustrating an example in which a plurality of measurement device units is provided according to another embodiment;

FIG. 19 is an explanatory diagram illustrating an example in which a plurality of measurement device units and a vehicle control device are provided according to another embodiment; and

FIG. 20 is an explanatory diagram schematically illustrating detection areas of the detectors during low-speed running.

### DETAILED DESCRIPTION OF THE PREFERRED EMBODIMENTS

For example, refer to JP 2007-145327 A, if a large number of sensors is aggregated and mounted as a measurement device unit in a vehicle, large amounts of data will be transmitted from the sensors to the control device provided in the vehicle. Overlapping of detection areas of the sensors may bring about a problem of exceeding the upper limit of the communication bandwidth and the upper limit of communication processing capacity of the control device. On the other hand, limiting the overlapping of the detection areas of the sensors may cause a problem of reduction in the accuracy of diagnosis and calibration of the sensors.

Therefore, there is demand for suppressing the amount of detection data and improving the accuracy of diagnosis and calibration of the detectors in the measurement device unit.

The present disclosure can be implemented in the following aspects.

In a first aspect, there is provided a vehicle-mounted measurement device unit. The vehicle-mounted measurement device unit according to the first aspect includes a data processing device including: a plurality of input units, each of which being connected to a corresponding one of a plurality of detectors having respective predetermined detection areas; an output unit configured to be connected to a vehicle control device arranged in a vehicle; an overlapping detection area setting unit configured to dynamically set an overlapping detection area between a plurality of arbitrary detectors among the plurality of detectors, for use during measurement and during non-measurement, or for use under normal conditions and under abnormal conditions; and an integrated data generation unit configured to, in accordance with the set overlap detection area, generate integrated data using detection data corresponding to the detection areas input from the plurality of detectors via the plurality of input units and output the integrated data via the output unit.

According to the vehicle-mounted measurement device unit in the first aspect, it is possible to suppress the amount of detection data in the measurement device unit and improve the accuracy of diagnosis and calibration of the detectors.

In a second aspect, there is provided an integrated data generation method in a vehicle-mounted measurement device unit. The integrated data generation method according to the second aspect includes: receiving detection data from a plurality of detectors having respective predetermined detection areas; dynamically setting an overlapping detection area between a plurality of arbitrary detectors among the plurality of detectors, for use during measurement and during non-measurement, or for use under normal conditions and under abnormal conditions; generating integrated data using the detection data from the plurality of detectors in accordance with the set overlapping detection area; and transmitting the integrated data to a control device arranged in a vehicle.

According to the integrated data generation method in the vehicle-mounted measurement device unit in the second aspect, it is possible to suppress the amount of detection data in the measurement device unit and improve the accuracy of diagnosis and calibration of the detectors. The present disclosure can also be implemented as an integrated data generation program or a computer-readable recording medium that records the program.

Hereinafter, a vehicle-mounted measurement device unit and an integrated data generation method in the measurement device unit according to the present disclosure will be described based on some embodiments.

### First Embodiment

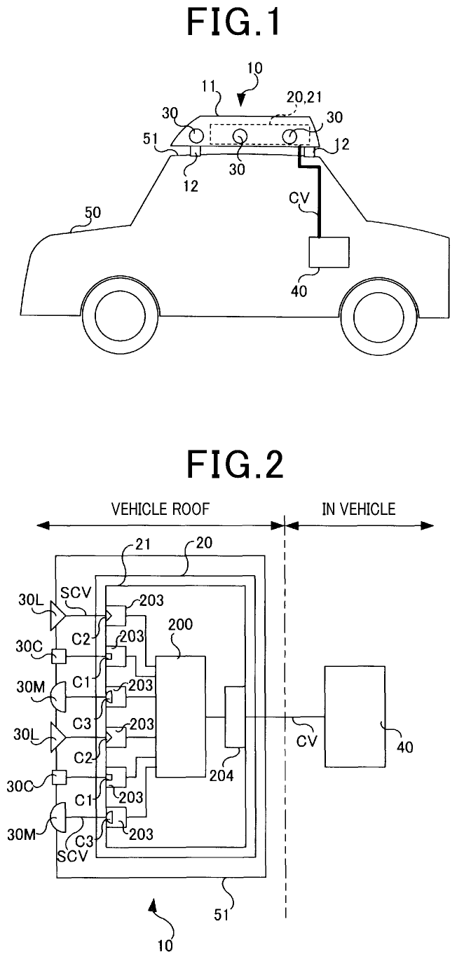

As illustrated in FIG. 1, a vehicle-mounted measurement device unit 10 according to a first embodiment is mounted to a vehicle 50. The measurement device unit 10 only needs to include at least a data processing device 21, and in the present embodiment, the measurement device unit 10 further includes a plurality of detectors 30 arranged around a main body 20, for example, on the front, rear, right, and left sides of, and above the main body 20. In the present embodiment, a data processing device 21 is desirably provided outside the vehicle 50 and contained in the main body 20. The main body 20 may be partly or entirely formed of a non-metallic material such as resin, for example, reinforced resin or carbon fiber, or may be partly or entirely formed of a metallic material such as aluminum or stainless steel. The main body 20 may further be formed of both a metallic material and a non-metallic material, for example, such that a plurality of components such as upper and lower cases, a box body, and a lid body is combined together via resin or rubber seal members. The measurement device unit 10 further includes a frame not illustrated and a fixing mechanism 12 for fixing the measurement device unit 10 to the vehicle 50. The fixing mechanism 12 may be, for example, an attachment mechanism for attachment to a roof rail provided in a roof 51 of the vehicle 50, or may be an attachment mechanism to be attached between the roof 51 and the upper part of the door of the vehicle 50. The data processing device 21 is provided in the main body 20 including a water-proof structure. According to the measurement device unit 10 having such a structure, the detectors 30 and the main body 20 can be mounted to the vehicle 50 regardless of the shape of the vehicle 50. A vehicle control device 40 is provided in the vehicle 50. The vehicle control device 40 includes, for example, a driver assistance control device for providing driver assistance such as braking assistance, steering assistance, and driving assistance using information on target objects around the vehicle 50 input from the measurement device unit 10. In the first embodiment, the measurement device unit 10, specifically, the data processing device 21 and the vehicle control device 40 are connected to each other via one cable CV. The number of the cable(s) CV may be sufficiently small relative to the number of the detectors 30, and is desirably 1/10 or less of the total number of the detectors 30, for example. More desirably, the number of the cables CV is one.

As illustrated in FIG. 2, the measurement device unit 10 according to the first embodiment includes the data processing device 21 in the main body 20 and the plurality of detectors 30 around the main body 20. In the present embodiment, the detectors will be collectively described with reference sign 30. The plurality of detectors 30 may include a camera 30C, a lidar 30L, and a millimeter wave radar 30M. The main body 20 covers the entire data processing device 21 and some of the plurality of detectors 30. The data processing device 21 includes an integrated data generation unit 200, a plurality of detector input units 203, and an output unit 204.

Each of the plurality of detector input units 203 in the data processing device 21 is connected to a corresponding one of the plurality of detectors 30. Each of the detector input units 203 and the corresponding one of the detectors 30 are connected together via a cable SCV. Each of the detector input units 203 includes a connection part, each of a plurality of connection parts C1, C2, and C3 of the detector input units 203 is shaped in correspondence with the shape of the connection terminal for the cable SCV included in the corresponding one of the detectors 30c, 30L, and 30M. Each of the detector input units 203 is connected to the integrated data generation unit 200 via an internal cable. Each of the detector input units 203 is implemented by dedicated integrated circuits for implementing physical layers of each communication protocol, that is, PHY chips, and converts the communication protocol employed by the corresponding one of the detectors 30 into the communication protocol employed by the integrated data generation unit 200. Each of the detectors 30 and the data processing device 21 communicate, for example, under a communication protocol such as Ethernet (registered trademark) (100M, 1G), Flat Panel DisplayLink (FPD-LINK), Gigabit Video Interface (GVIF), Low voltage differential signaling (LVDS) such as Gigabit Multimedia Serial Link (GMSL), or HDBASE-T. In the example of FIG. 2, the plurality of detector input units 203 each includes the corresponding one of the connection parts C1, C2, and C3. Alternatively, a single detector input unit 203 may include a plurality of connection units C1, C2, and C3 and be connected to the integrated data generation unit 200 via one internal cable. In this case, the detector input units 203 transmits detection information detected by each of the detectors 30 to the integrated data generation unit 200 through communication using a multiplex system, for example, frequency-division multiplex system and time-division multiplex system.

The cameras 30C are imaging devices including an imaging element such as a CCD or an imaging element array, and are sensors that receive visible light to output detection results of outer shape information or shape information of a target object as image data. The lidars 30L are sensors that emit infrared laser light and receive reflection light from a target object to detect the distance from the target object to the vehicle 50, and the relative velocity and angle of the target object. The millimeter wave radars 30M are sensors that emit a millimeter wave and receive a reflection wave from a target object to detect the distance from the target object to the vehicle 50 and the relative velocity and angle of the target object. Each of the detectors 30 may process the light-reception intensity or reception intensity obtained by detection and output detection data including detection point sequences and images to the integrated data generation unit 200, or may directly output raw data of light-reception intensity or reception intensity obtained by detection to the integrated data generation unit 200. In the latter case, the integrated data generation unit 200 executes various processes such as image correction, reversible or irreversible image compression, and demosaicing. The vehicle control device 40 may perform processes such as image correction and demosaicing. In this case, the vehicle control device 40 may request, from the integrated data generation unit 200, detection data to be transmitted, according to the running state of the vehicle 50, and the integrated data generation unit 200 may generate integrated data that integrates the requested raw data and transmit the integrated data to the vehicle control device 40. The detection data to be transmitted means detection data from the detectors 30 determined based on the installation positions and type of the detectors 30. Alternatively, the integrated data generation unit 200 may select detection data in accordance with the running state of the vehicle 50 or a predetermined condition, and generate integrated data that integrates the corresponding raw data, and transmit the integrated data to the vehicle control device 40.

The output unit 204 in the data processing device 21 is connected to the vehicle control device 40 arranged in the vehicle 50 via the cable CV. The output unit 204 is implemented by dedicated integrated circuits for implementing physical layers of each communication protocol, that is, PHY chips. The output unit 204 performs a protocol conversion process on the integrated data generated by the data processing device 21 to convert the communication protocol employed by the data processing device 21 into the communication protocol employed by the vehicle control device 40, and transmits the converted integrated data to the vehicle control device 40. The number of input cables to the data processing device 21 corresponds to the number of the detectors 30, whereas in the present embodiment the number of output cables from the data processing device 21 is one, thereby decreasing the number of cables between the data processing device 21 and the vehicle control device 40. The communication between the data processing device 21 and the vehicle control device 40 is performed using a communication protocol, for example, such as Ethernet (10 G or higher), LVDS (FPD-LINK, GVIF, GMSL), or HDBASE-T. The data processing device 21 included in the measurement device unit 10 according to the first embodiment can accommodate and handle hardware-related differences in the connection terminal shape of cables for the detectors 30 and software-related differences in communication protocol for the detectors 30, thereby providing a virtual common input unit to the vehicle control device 40.

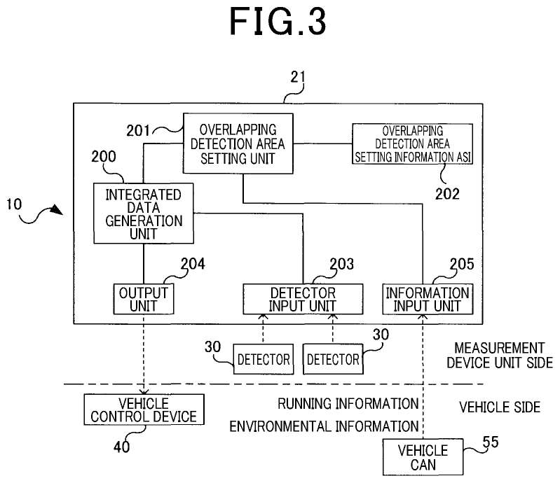

As illustrated in FIG. 3, the data processing device 21 includes the integrated data generation unit 200, an overlapping detection area setting unit 201, a memory 202, the detector input units 203, the output unit 204, and an information input unit 205. The data processing device 21 is implemented hardware-wise by an integrated circuit. The integrated data generation unit 200 is implemented by one or more preprogrammed integrated circuits such as FPGA, ASIC or SOC. The integrated data generation unit 200 performs an integrated data generation process of generating integrated data to be transmitted to the vehicle control device 40, using the detection data acquired from the detectors 30. The integrated data is data adjusted in the amount of the detection data from the detectors 30 so as not to exceed the communication band between the data processing device 21 and the vehicle control device 40. The integrated data includes the detection data in amounts allocated to the detectors 30 under a condition. The amount of data not exceeding the communication band means at least one of not exceeding the communication capacity that can be transmitted by the cable CV and not exceeding the data capability that can be processed by the vehicle control device 40. The condition, in the present embodiment, means the state of the detectors 30 such as during measurement, during calibration or diagnosis, or under fault conditions. The overlapping detection area setting unit 201 dynamically sets an overlapping detection area between a plurality of arbitrary detectors 30 among the plurality of detectors 30. More specifically, the overlapping detection area setting unit 201 sets a measurement-time overlapping detection area for use during measurement, and the overlapping detection area setting unit 201 sets a non-measurement-time overlapping detection area larger than the measurement-time overlapping detection area for use during diagnosis or calibration. The data processing device 21 and the vehicle control device 40 are connected together via one cable, and there is an upper limit on the communication band, that is, the amount of transmission data. The overlapping detection area means overlapping of the detection area of each detector 30, that is, redundancy of the detection data. If the overlapping detection area is large, the amount of detection data increases. Therefore, during measurement, the overlapping detection area is set in consideration of a specification in the communication band, that is, the upper limit. During non-measurement such as during diagnosis or calibration, the overlapping detection area formed by the detectors 30 to be calibrated is expanded to improve the accuracy of the calibration. The communication band means the amount of data that can be transmitted per unit time, similarly to the terms such as transmission rate and transfer speed. In general, the communication band is determined at the reception side in accordance with the amount of data processible per unit time without buffer overwriting or data discarding.

A plurality of arbitrary detectors 30 among the plurality of detectors 30 may be, but not limited to, two adjacent detectors 30 among adjacent three detectors 30, for example. “During measurement” means during object detection such as distance measurement from the vehicle 50 to an object around the vehicle 50 and object type discrimination by the measurement device unit 10, but does not determine the states of the detectors 30. “During diagnosis or calibration” means during execution of diagnosis process of the operating states of the detectors 30 or during execution of calibration process of detecting the amounts of shift of the detectors 30 from an optical axis, but object detection is not executed. If the detectors 30 have no scanning capability, that is, the detection areas cannot be physically changed, in accordance with the overlapping detection area set by the overlapping detection area setting unit 201, the integrated data generation unit 200 achieves the measurement-time overlapping detection area by reducing the detection data corresponding to at least a part of the overlapping detection area from at least one piece of detection data from the plurality of arbitrary detectors 30 at generation of the integrated data. The integrated data generation unit 200 achieves the non-measurement-time overlapping detection area by maintaining the detection data corresponding to the overlapping detection area in the detection data from the plurality of arbitrary detectors 30. If the detectors 30 have scanning capability, the integrated data generation unit 200 may achieve the measurement-time overlapping detection area and the non-measurement-time overlapping area by instructing scanning control actuators of the detectors 30 to increase or decrease the scanning angle range. The memory 202 stores overlapping detection area setting information ASI for setting the overlapping detection area in a nonvolatile and read-only manner. The overlapping detection area setting information ASI is information in which the target detectors to be changed in detection area are associated with the amounts of area expansion relative to the standard detection areas of the target detectors. The target detector may be a predetermined detector 30 included in the plurality of adjacent detectors 30 or may be all the plurality of adjacent detectors 30. The amounts of detection area expansion may be predetermined in accordance with the positions of the detectors 30 or the identical amount of area expansion may be predetermined for all the detectors 30. The overlapping detection area setting unit 201 refers to the overlapping detection area setting information ASI in the memory 202 to acquire the target detector and the amount of area expansion of the target detector and then outputs the information to the integrated data generation unit 200. The overlapping detection area setting information ASI may be provided in the overlapping detection area setting unit 201.

The plurality of different types of detectors 30 is connected to the detector input units 203 via detection signal lines that are cables. The detectors 30 input detection data to the detector input units 203. The vehicle control device 40 is connected to the output unit 204 via an integrated data signal line that is a cable. The output unit 204 outputs the integrated data to the vehicle control device 40. A vehicle CAN 55 is connected to the information input unit 205 via a cable. The vehicle CAN 55 inputs running information and environmental information to the information input unit 205.

The vehicle control device 40 controls the outputs of the inner combustion engine and the motor in accordance with the driver's accelerator pedal operations or regardless of the driver's accelerator pedal operations, and applies brakes by the braking device regardless of the driver's braking pedal operations, or performs steering by the steering device regardless of the driver's steering wheel operations.

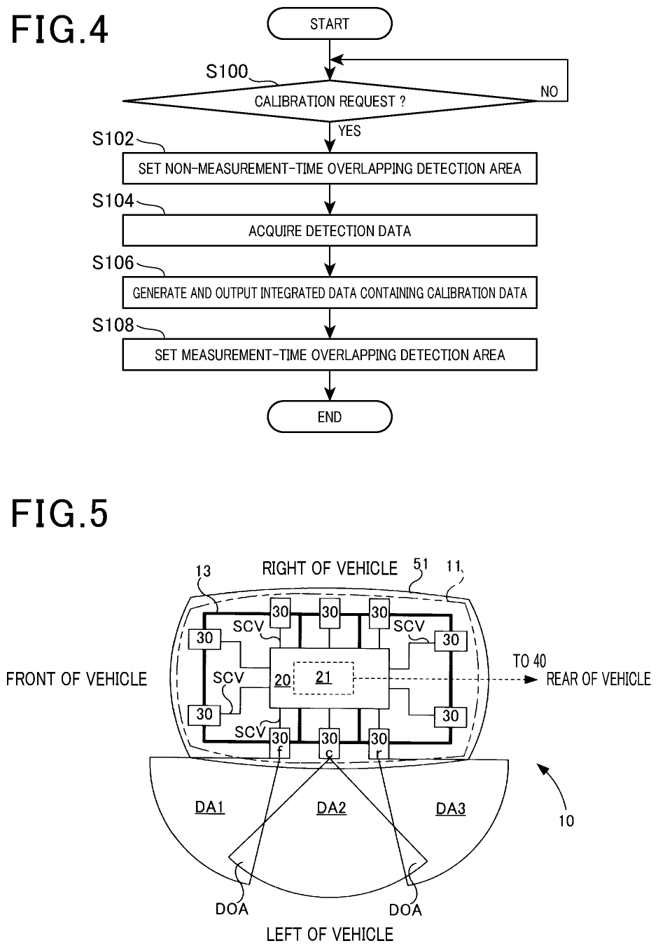

An overlapping detection area setting process and an integrated data generation process executed by the data processing device 21 according to the first embodiment will be described. The process routine illustrated in FIG. 4 is started when the control system in the vehicle is activated or the start switch is turned on. The process routine illustrated in FIG. 4 may be started with the issuance of a calibration request as a trigger, instead of step S100. At the start of the process routine illustrated in FIG. 4, as default overlapping detection areas, measurement-time overlapping detection areas DOA are set.

The overlapping detection area setting unit 201 determines whether a calibration request has been issued (step S100). The calibration request is transmitted from the vehicle CAN 55 to the overlapping detection area setting unit 201 via the information input unit 205. The vehicle control device 40 may output a calibration request to the vehicle CAN 55 at predetermined time intervals, for example, at every 200-km running, every 30 days, or every 30 running times. Otherwise, the vehicle control device 40 may output a calibration request to the vehicle CAN 55 if it is determined from the results of a fusion process using the detection data that there is a positional shift between two detectors 30 or no detection data is obtained. The vehicle control device 40 may output a calibration request to the data processing device 21 via the cable CV if a communication protocol allowing bidirectional communication between the vehicle control device 40 and the data processing device 21 is used. In addition to the foregoing conditions, the vehicle control device 40 issues a calibration request if a certain condition is satisfied, for example, if the vehicle 50 is stopped at a stoplight or in a traffic jam, or the vehicle 50 is an autonomous vehicle and is pulled over to a road shoulder. Instead of the vehicle control device 40, the integrated data generation unit 200 may issue a calibration request.

The overlapping detection area setting unit 201 waits until the issuance of a calibration request (step S100: No). If determining that a calibration request has been issued (step S100: Yes), the overlapping detection area setting unit 201 uses the overlapping detection area setting information ASI to set the non-measurement-time overlapping detection area (step S102). The non-measurement-time overlapping detection area is set by determining the target detector of which the detection area is to be expanded and the expansion amount of detection area of the target detector, that is, expansion detection area. Since an overlapping detection area is formed by an overlap between the detection areas of a plurality of adjacent detectors 30, the detection area of at least one of the plurality of adjacent detectors 30 is expanded to set the non-measurement-time overlapping detection area that is expanded beyond the measurement-time overlapping detection area DOA. Hereinafter, the setting of the non-measurement-time overlapping detection area will be described taking three detectors 30 arranged on the left side of the vehicle 50, a front detector 30f, a central detector 30c, and a rear detector 30r as an example. The measurement-time overlapping detection areas DOA are sized as illustrated in FIG. 5, for example. In the example of FIG. 5, the front detector 30f, the central detector 30c, and the rear detector 30r include detection areas DA1, DA2, and DA3, respectively.

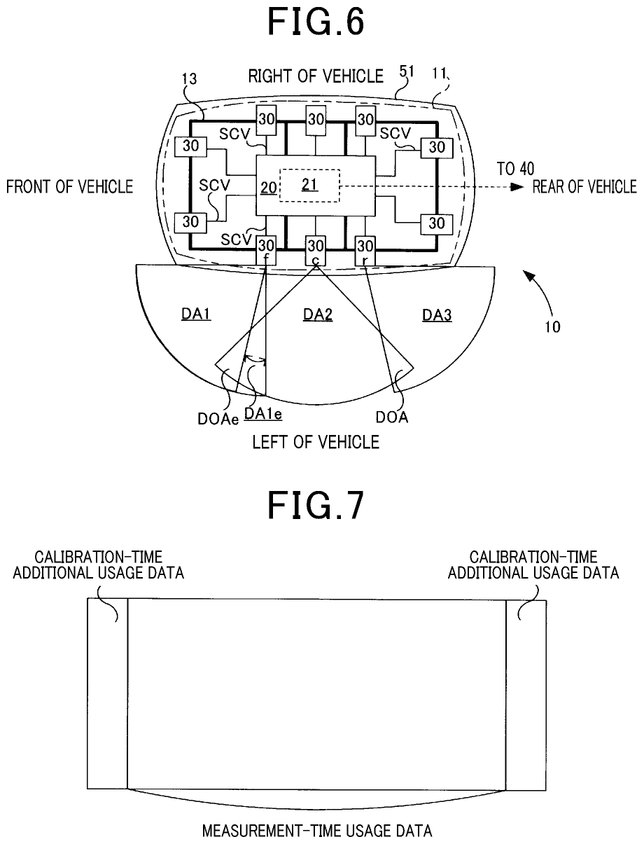

The detection areas DA1, DA2, and DA3 during measurement correspond to standard detection areas. The front detector 30f and the central detector 30c have the measurement-time overlapping detection area DOA in which their respective detection areas DA1 and DA2 overlap. The central detector 30c and the rear detector 30r have the measurement-time overlapping detection area DOA where their respective detection areas DA2 and DA3 overlap. In contrast to this, during calibration, as illustrated in FIG. 6, for example, the front detector 30f is determined as a target detector, the amount of expansion of the detection area DA1 of the front detector 30f, that is, an expansion detection area DA1e is determined, and a non-measurement-time overlapping detection area DOAe is set.

The set non-measurement-time overlapping detection area DOAe can be implemented as described below. If the detector 30 is the camera 30C and has a mechanism capable of physical scanning, the non-measurement-time overlapping detection area DOAe can be implemented by controlling the scanning of the front detector 30f such that the detection area of the front detector 30f is expanded toward the central detector 30c. On the other hand, if the camera 30C has no mechanism capable of physical scanning, the detection area of the camera 30C can be substantially expanded software-wise, that is, upon data, as described below. FIG. 7 schematically illustrates the image data acquired by the camera 30C and the angle of view in association with each other. In the present embodiment, in order to keep the amount of integrated data at the upper limit or less of the communication band, calibration-time additional usage data is clipped, and only measurement-time usage data is used as detection data acquired by the detector 30 during measurement. The calibration-time additional usage data means detection data corresponding to at least part of the measurement-time overlapping detection area DOA, that is, detection data corresponding to the measurement-time overlapping detection area DOA of an arbitrary size from the largest measurement-time overlapping detection area DOA to the smallest measurement-time overlapping detection area DOA acquirable by the detector 30. That is, even during measurement, the overlapping detection area DOA is present and the detection data corresponding to the overlapping detection area DOA during measurement is contained in the measurement-time usage data. As a result of the clipping process, the angle of view of the camera 30C, that is, the detection area is limited to a range presented in the measurement-time usage data, thereby achieving the detection area DA1 and the measurement-time overlapping detection area DOA illustrated in FIG. 5. On the other hand, during calibration, the originally acquired calibration-time additional usage data is maintained as effective detection data without being clipped so that the angle of view of the camera 30C is widened to obtain the detection area DA1+the expanded detection area DA1e illustrated in FIG. 6, thereby achieving the non-measurement-time overlapping detection area DOAe. For easy explanation, in the foregoing description, the calibration-time additional usage data is all used. Alternatively, according to the expansion amount of the detection area determined by the overlapping detection area setting unit 201, the amount of clipping may be set as appropriate such that the calibration-time additional usage data may be partly used without setting the amount of clipping to zero, that is, without using all the calibration-time additional usage data. In this case, the angle of view of the camera 30C can be set to an arbitrary angle of view and the expanded detection area DA1e can be set to an arbitrary size.

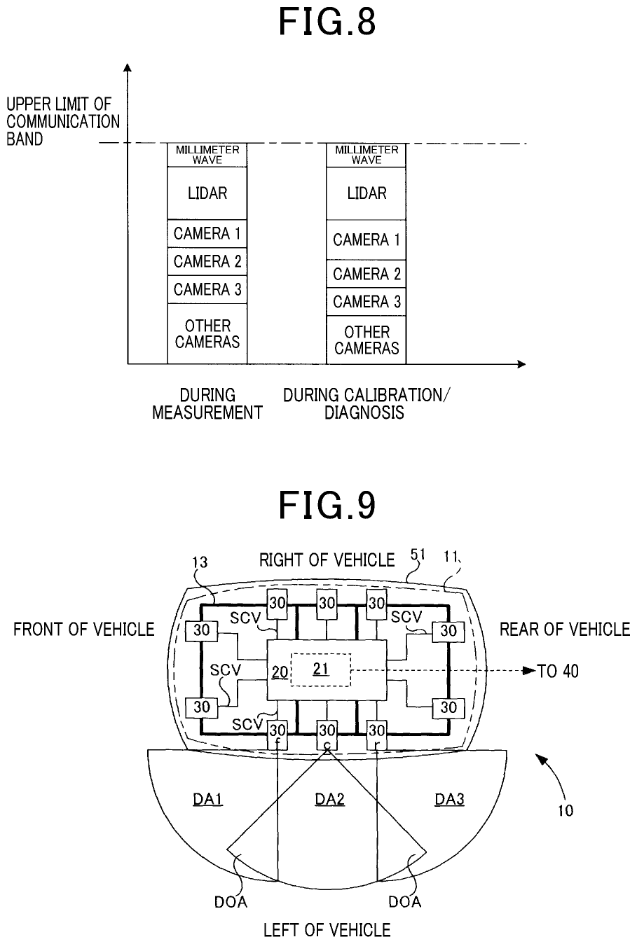

The integrated data generation unit 200 acquires the detection data from each of the detectors 30 (step S104). The detection data acquired from each of the detectors 30 is non-clipped detection data including the calibration-time additional usage data illustrated in FIG. 7. The integrated data generation unit 200 generates the integrated data including the calibration-time additional usage data and outputs the integrated data to the vehicle control device 40 (step S106). The integrated data generation unit 200 generates the integrated data so as to dynamically change the proportion of the detection data from each of a plurality of arbitrary detections 30 in the integrated data. Specifically, the integrated data generation unit 200 maintains the detection data from the target detector specified by the overlapping detection area setting unit 201, the front detector 30f illustrated in FIG. 6, that is, the integrated data generation unit 200 does not perform the clipping process on the detection data. The integrated data generation unit 200 performs the clipping process on the detection data from the detectors other than the target detector, the central detector 30c and the rear detector 30r illustrated in FIG. 6. The integrated data generation unit 200 further reduces the detection data from the detectors 30 other than the front detector 30f and the central detector 30c to be calibrated. The detectors 30 of which the amounts of detection data are to be reduced are the detectors 30 positioned on the right side of the vehicle opposite to the left side on which the front detector 30f and the central detector 30c to be calibrated are present, and are the cameras 30C of the same type as the front detector 30f, the central detector 30c, and the rear detector 30r. As a result, as illustrated in FIG. 8, the integrated data is generated such that the amount of detection data from the camera 1 meaning the front detector 30f is increased, the amounts of detection data from the camera 2 and the camera 3 meaning the central detector 30c and the rear detector 30r are maintained, and the amounts of detection data from the other cameras are decreased. The amount of detection data from the rear detector 30r not sharing the expanded overlapping detection area DOAe may also be decreased. The integrated data transmitted to the vehicle control device 40, that is, the integrated data for calibration is used by the vehicle control device 40 in the calibration process on the front detector 30f and the central detector 30c. The calibration process can be executed, for example, by extracting the amount of a shift of the same target object in the coordinate system in the expanded overlapping detection area DOAe and specifying the axis-shifted detector having an optical axis shift. The axis-shifted detector can be specified by extracting the amount of a shift in the overlapping detection area between adjacent detectors 30. The amount of a shift of the axis-shifted detector is applied to the detection data acquired from the axis-shifted detector as the amount of calibration, to thereby eliminate or reduce the axis shift.

The overlapping detection area setting unit 201 set a measurement-time overlapping detection area using the overlapping detection area setting information ASI (step S108), and then terminates the process routine. The measurement-time overlapping detection area is set by using the overlapping detection area setting information ASI to determine the target detector of which the detection area has been expanded and setting the amount of expansion of the detection area of the target detector to zero. As a result, the measurement-time overlapping detection areas DOA illustrated in FIG. 5 are achieved, and the vehicle control device 40 can execute the object detection process using the detectors 30, that is, the distance measurement process and the driver assistance control process.

In the measurement device unit 10 according to the first embodiment described above, the overlapping detection area between a plurality of arbitrary detectors 30 among the plurality of detectors 30 is dynamically set, and the integrated data is generated using the detection data corresponding to the detection areas input from the plurality of detectors 30, in accordance with the set overlapping detection area. This makes it possible to suppress the amount of detection data and improve the accuracy of diagnosis and calibration of the detectors. More specifically, the overlapping detection area setting unit 201 included in the measurement device unit 10 dynamically sets the overlapping detection area between a plurality of arbitrary detectors 30 among the plurality of detectors 30, that is, sets the measurement-time overlapping detection area for use during measurement and sets the non-measurement-time overlapping detection area DOAe larger than the measurement-time overlapping detection area DOA for use during diagnosis or calibration. As a result, during measurement with the small overlapping detection area, the detection area of each of the detectors 30 becomes small to decrease the amounts of detection data from each of the detectors 30, so that the integrated data can be generated including the detection data from each of the detectors 30 in desired proportions to improve the accuracy of object detection. On the other hand, during diagnosis or calibration, the overlapping detection area is expanded to set an overlapping detection area larger than that during measurement, to thereby improve the accuracy of diagnosis or calibration. During diagnosis or calibration, the detection areas of a plurality of detectors 30 related to the diagnosis or calibration become large to increase the amounts of the detection data, but the amounts of the detection data from a plurality of detectors 30 not related to the diagnosis or calibration are decreased to allow for generation of the integrated data including the detection data from each of the detectors 30 in desired proportions.

In the first embodiment, during execution of calibration is taken as an example. However, the first embodiment can be similarly applied during execution of diagnosis of the detectors 30. That is, the overlapping detection area setting process and the integrated data generation process illustrated in FIG. 4 may be performed with the input of a diagnosis request from the vehicle control device 40 to the data processing device 21 as a trigger, instead of a calibration request. The detectors 30 generally have a self-diagnosis function. However, the high-accuracy diagnosis using image data puts heavy processing load on the detectors 30 and is not suitable for self-diagnosis of the detectors 30. The objective diagnosis using an overlapping detection area cannot be performed by the self-diagnosis function of each of the detectors 30. Therefore, as described above in relation to the first embodiment, the accuracy of diagnosis is improved by the vehicle control device 40 executing the diagnosis using the overlapping detection area. The diagnosis request may be issued under the same condition as that for the calibration request. The diagnosis request may be issued by the vehicle control device 40 or the overlapping detection area setting unit 201 upon receipt of a request from each of the detectors 30 as a result of the self-diagnosis by the detectors 30.

In the first embodiment, the camera 30C is taken as an example. Alternatively, the first embodiment can be applied similarly to the lidar 30L or the millimeter wave radar 30M. The lidar 30L and the millimeter wave radar 30M generally have a scanning function, and the scanning range can be set arbitrarily in the range allowable for the structure of the apparatus. However, in the case of generating integrated data with a large overlapping detection area during measurement, the upper limit of the communication band may be exceeded. Thus, dynamically switching the overlapping detection area during measurement and during non-measurement suppresses the amount of the detection data and improves the accuracy of the calibration or diagnosis.

In the first embodiment, the detection area of the front detector 30f is expanded as an example. In addition to the front detector 30f, the detection area of the central detector 30c may be expanded. That is, if the detector to be calibrated is at least one of the front detector 30f and the central detector 30c, both the detection areas DA1 and DA2 of the front detector 30f and the central detector 30c relating to the calibration process may be expanded. In this case, it is possible to reduce the amounts of expansion of the detection areas of each detector 30f and 30c as compared to the case where the detection area of any one detector is expanded, and improve the degree of freedom of setting the overlapping detection area.

In the first embodiment, the vehicle control device 40 performs the calibration process or the diagnosis process. Alternatively, the data processing device 21 may perform the calibration process or the diagnosis process. In this case, during calibration process or diagnosis process performed by the data processing device 21, process may be performed using the calibration-time additional usage data, that is, the non-measurement-time overlapping detection area DOAe, and generate the integrated data using the detection data from which the calibration-time additional usage data is deleted. In this mode as well, it is possible to reduce the amount of detection data and improve the accuracy of calibration or diagnosis.

### Second Embodiment

In relation to a second embodiment, setting of an overlapping detection area in the event of a failure in any of the detectors 30 will be described. In the second embodiment, under fault conditions where any one of the plurality of arbitrary detectors fails, an overlapping detection area setting unit 201 sets a failing-time overlapping detection area so as to expand the detection area of another one of the plurality of arbitrary detectors and compensate for the detection area of the determined failing detector. The configuration of a measurement device unit in the second embodiment is similar to that of the measurement device unit 10 in the first embodiment, and thus its components are denoted with reference signs identical to those of the first embodiment and description thereof will be omitted. As illustrated in FIG. 9, a plurality of detectors 30 arranged on the left side of a vehicle 50, that is, a front detector 30f, a central detector 30c, and a rear detector 30r will be described as an example. Under normally working conditions, the detectors 30f, 30c, and 30r have detection areas DA1, DA2, and DA3 illustrated in FIG. 9, respectively. As a result, a measurement-time overlapping detection area DOA is formed between the front detector 30f and the central detector 30c and between the central detector 30c and the rear detector 30r, and a measurement-time overlapping detection area DOA is not formed between the front detector 30f and the rear detector 30r.

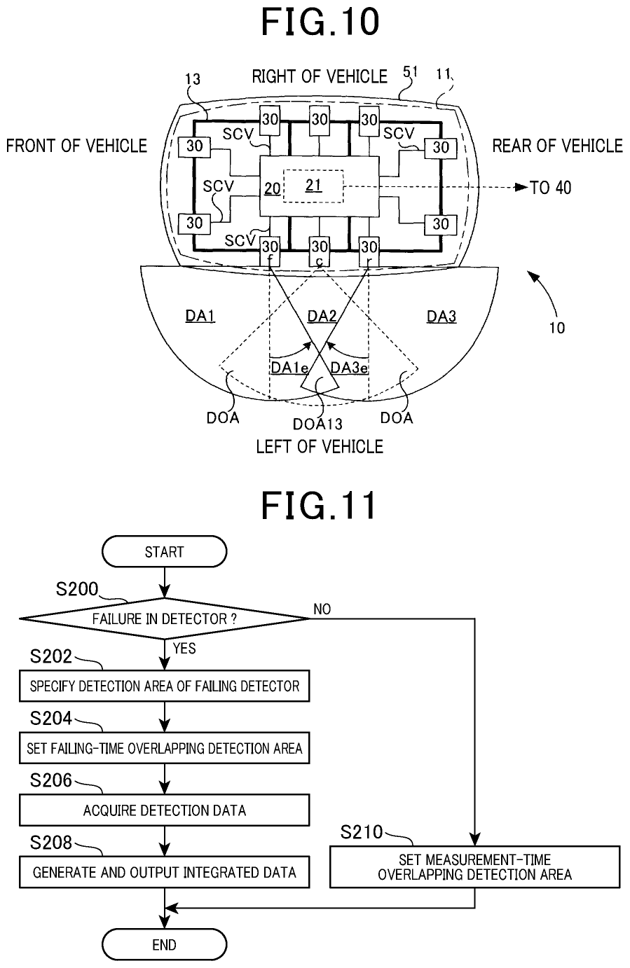

In contrast to this, if one of the plurality of detectors 30 fails, the overlapping detection area is dynamically set between a plurality of arbitrary normal detectors 30 among the plurality of detectors 30. The plurality of arbitrary detectors 30 among the plurality of detectors 30 is, for example, but not limited to, two detectors 30 excluding the central detector among three adjacent detectors 30 or three detectors 30 other than the one detector 30 among four adjacent detectors 30. More specifically, as illustrated in FIG. 10, if the central detector 30c fails, the detection areas DA1 and DA3 of the front detector 30f and the rear detector 30r are expanded by expansion detection areas DA1e and DA3e, respectively, to thereby form a failing-time overlapping detection area DOA 13 between the front detector 30f and the rear detector 30r.

An overlapping detection area setting process and an integrated data generation process executed by a data processing device 21 according to the second embodiment will be described. The process routine illustrated in FIG. 11 is started, for example, when a control system in the vehicle is activated or the start switch is turned on. The process routine illustrated in FIG. 11 may be started with detection of a failure as a trigger, instead of step S200. At the start of the process routine illustrated in FIG. 11, measurement-time overlapping detection areas DOA are set as default overlapping detection areas.

The overlapping detection area setting unit 201 determines whether a failure has occurred in any of the detectors (step S200). The determination on whether a failure has occurred in any of the detectors may be executed upon a notification of failure occurrence. The notification of failure occurrence may be determined by the vehicle control device 40 and may be transmitted from a vehicle CAN 55 to the overlapping detection area setting unit 201 via an information input unit 205. If the detectors 30 make failure determination by self-diagnosis, the failing detector 30 may notify a failure occurrence to the overlapping detection area setting unit 201. The vehicle control device 40 may determine the detection of failure occurrence, for example, based on the results of a diagnosis process using the non-measurement-time overlapping detection area DOAe described above in relation to the first embodiment or based on data loss or reduction in signal intensity during measurement. The detection of failure occurrence may be determined by the data processing device 21, for example, the integrated data generation unit 200, based on data loss or reduction in signal intensity when generating integrated data. The vehicle control device 40 may make a final determination using compositely using these determination results. The final determination may be made by rule of majority based on the number of failure determinations. Otherwise, weights may be assigned to the determination results, and a final determination on failure occurrence may be made if a predetermined threshold is exceeded.

If no failure has occurred in the detectors (under normal conditions) (step S200: No), the overlapping detection area setting unit 201 sets the measurement-time overlapping detection areas DOA (step S210), and this process routine is terminated. If determining that a failure has occurred in any of the detectors (step S200: Yes), the overlapping detection area setting unit 201 identifies the failing detector in which the failure has occurred, and locates the detection area of the failing detector using the overlapping detection area setting information ASI (step S202). The overlapping detection area setting information ASI contains information on the arrangement and detection area information of the detectors in association with each other. Thus, the detection area of the failing detector can be located by identifying the failing detector. A detection area corresponds to the scanning range or angle-of-view range in which a detector handles detection or monitoring. The overlapping detection area setting unit 201 sets the failing-time overlapping detection area DOA 13 so as to compensate for the detection area of the identified failing detector (step S204). The failing-time overlapping detection area DOA 13 is set by using the overlapping detection area setting information ASI to determine the target detector of which the detection area is to be expanded and the expansion amount of the detection area of the target detector, that is, the expansion detection area. Specifically, referring to FIG. 10, the front detector 30f and the rear detector 30r adjacent to the central detector 30c, which is identified as the failing detector using the overlapping detection area setting information ASI, are identified, and the detection areas of the front detector 30f and the rear detector 30r are set so as to compensate for the detection area DA2 of the failing detector 30c. Specifically, the overlapping detection area between the front detector 30f and the rear detector 30r, that is, the failing-time overlapping detection area DOA 13 is set. As can be seen from FIG. 9, under normal conditions, there is no overlapping detection area between the front detector 30f and the rear detector 30r, and under fault conditions, there is the failing-time overlapping detection area DOA 13. That is, the overlapping area is formed in correspondence with the overlapping detection area generally set between adjacent detectors 30. The failing-time overlapping detection area DOA 13 is achieved by setting the detection area of the front detector 30f as the detection area DA1+the expansion detection area DA1e and setting the detection area of the rear detector 30r as the detection area DA3+the expansion detection area DA3e.

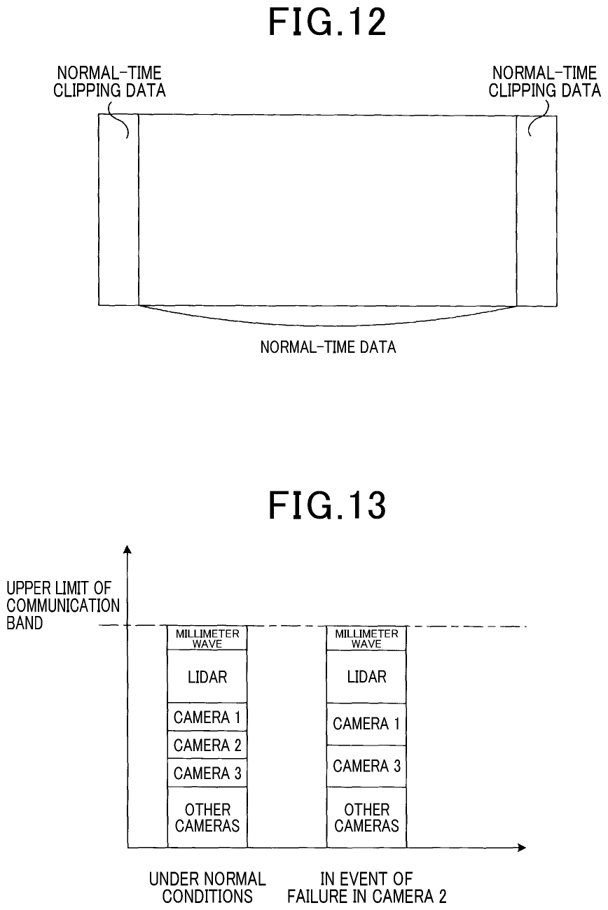

The set failing-time overlapping detection area DOA 13 can be achieved in a manner as described below. If the cameras 30C are used as detectors 30 and include a mechanism capable of physical scanning, the failing-time overlapping detection area DOA 13 can be achieved by controlling the scanning by the front detector 30f and the rear detector 30r such that the detection areas of the front detector 30f and the rear detector 30r expand toward the central detector 30c. On the other hand, if the cameras 30C have no mechanism capable of physical scanning, the detection areas of the cameras 30C can be substantially expanded software-wise, that is, upon data. FIG. 12 schematically illustrates image data acquired by the cameras 30C. In the present embodiment, in order to keep the amount of integrated data at the upper limit or less of the communication band, the normal-time clipping data is clipped during measurement, and only the normal-time data is used as detection data acquired by the detectors 30. As a result of the clipping process, the fields of view of the cameras 30C, that is, the detection areas are limited to a range where the measurement-time usage data can be shown, so that the detection areas DA1 to DA3 and the measurement-time overlapping detection areas DOA illustrated in FIG. 9 are achieved. The normal-time data is data corresponding to the detection areas of the detectors 30 under normal conditions, which includes data corresponding to the detection areas capable of forming the measurement-time overlapping detection areas DOA. The normal-time clipping data is data to be deleted in order to maintain the upper limit of communication band for the integrated data under normal conditions, where the normal-time data is excluded from the data acquirable by the detectors 30. Under fault conditions, the failing-time overlapping detection area DOA 13 is achieved by maintaining the normal-time clipping data in the detection data from the detectors that compensates for the failing detector. Since no clipping process is executed, the originally acquired normal-time clipping data is maintained as effective detection data, to thereby widen the angles of view of the cameras 30C. Accordingly, the detection area DA1+the expansion detection area DA1e and the detection area DA3+the expansion detection area DA3e illustrated in FIG. 10 are obtained to achieve the failing-time overlapping detection area DOA 13.

The integrated data generation unit 200 acquires the detection data from each of the detectors 30 (step S206). The detection data acquired from each of the detectors 30 is non-clipped detection data that contains the normal-time clipping data illustrated in FIG. 12. The integrated data generation unit 200 generates integrated data containing the normal-time clipping data, and outputs the integrated data to the vehicle control device 40 (step S208), and then this process routine is terminated. The integrated data generation unit 200 deletes the normal-time clipping data from the detection data from a plurality of arbitrary detectors to achieve the measurement-time overlapping detection areas DOA set by the overlapping detection area setting unit 201. The integrated data generation unit 200 maintains the normal-time clipping detection data in the detection data from the detectors other than the failing detector among the plurality of arbitrary detectors to achieve the failing-time overlapping detection area DOA 13 set by the overlapping detection area setting unit 201. Specifically, the integrated data generation unit 200 maintains the detection data from the front detector 30f and the rear detector 30r adjacent to the failing target detector specified by the overlapping detection area setting unit 201, the central detector 30c illustrated in FIG. 10, that is, does not execute the clipping process on the detection data. The integrated data generation unit 200 executes the clipping process on the detection data from the detectors 30 other than the front detector 30f and the rear detector 30r, that is, the detectors 30 positioned on the front, right, and rear sides of the vehicle 50 illustrated in FIG. 10, and does not use the detection data from the central detector 30c that is the failing detector even if it is acquired. Consequently, as illustrated in FIG. 13, the data amount allocated to the camera 2 meaning the central detector 30c is re-allocated to the camera 1 meaning the front detector 30f and the camera 3 meaning the rear detector 30r, and the integrated data is generated such that the amounts of detection data from the camera 1 and the camera 3 are increased. The integrated data transmitted to the vehicle control device 40 can be used by the vehicle control device 40 to execute the object detection processes, that is, the distance measurement process and the driving assist control process. If any of the detectors 30 fails, the accuracy of the processes performed by the vehicle control device 40 using the detection data from the detectors 30 will become lowered. Thus, preferably, some announcement, indication, or sound is provided to urge the driver to obtain maintenance, or a notification of the failure is provided to a vehicle management center using vehicle-mounted wireless service.

As described above, in the measurement device unit 10 according to the second embodiment, under fault condition where any one of a plurality of arbitrary detectors 30 fails, the detection areas of non-failing detectors 30 among the plurality of arbitrary detectors 30 are expanded to set the failing-time overlapping detection area DOA 13 that compensates for the detection area of the failing detector. This makes it possible to suppress the amount of detection data and suppress or prevent reduction in the accuracy of object detection in the event of a failure in any of the detectors. More specifically, the overlapping detection area setting unit 201 included in the measurement device unit 10 dynamically sets the overlapping detection area between a plurality of arbitrary detectors 30 among the plurality of detectors 30. That is, under normal conditions, the overlapping detection area setting unit 201 sets the measurement-time overlapping detection areas DOA, and under fault condition, the overlapping detection area setting unit 201 sets the failing-time overlapping detection area DOA 13 that compensates for the detection area of the failing detector. As a result, under normal conditions, the detection areas of the detectors 30 become small and the amount of detection data from the detectors 30 decreases so that it is possible to generate the integrated data containing detection data from the detectors 30 in desired proportions, thereby improving the accuracy of object detection. On the other hand, under fault conditions, the detection area is expanded to set the overlapping detection area that compensates for the detection area of the failing detector, thereby suppressing or preventing reduction in the accuracy of object detection.

### Third Embodiment

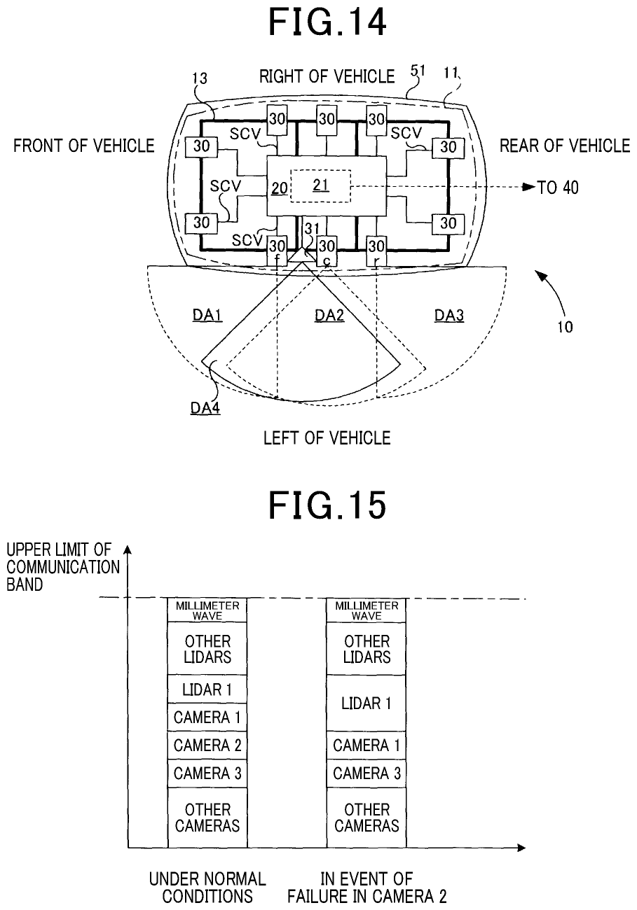

In the second embodiment, the same type of plurality of detectors 30, that is, the cameras 30C are used. Alternatively, different types of detectors 30 may compensate for the detection area of a failing detector. Except for the addition of detector types, a measurement device unit in a third embodiment has a configuration similar to that of the measurement device unit 10 in the first embodiment. Thus, components of the measurement device unit in the third embodiment are denoted with identical reference signs as those of the first embodiment and description thereof will be omitted. In the measurement device unit 10, in order to secure the redundancy of detectors 30, detectors 30f, 30c, and 30r, that are cameras, a lidar 31, and a millimeter wave radar not illustrated are arranged to cover the same area as illustrated in FIG. 14. In this arrangement of the detectors, if the central detector 30c fails, the information of a detection area DA2 not acquired by the failing central detector 30c may be compensated for by the lidar 31 that is arranged near the central detector 30c and has a detection area DA4 at least partly overlapping the detection area of the central detector 30c. More specifically, the resolution or resolving power of the lidar 31 is increased to compensate for the detection data obtained by the central detector 30c that is the camera 30C. The camera 30C and the lidar 31 can both output pixel image data, and can complement each other's pixel information. As the result of increase in the resolution or resolving power of the lidar 31, the amount of detection data output by the lidar 31 increases. However, as illustrated in FIG. 15, the data amount assigned to the camera 2 that is the central detector 30c can be re-assigned to the lidar 31 to generate the integrated data that is equal to or smaller than the upper limit of the communication band.

In the foregoing description, the failure of the camera 30C is compensated for by the lidar 31. In turn, the failure of the lidar 31 may be compensated for by the camera 30C. Further, a similar mutual complement process may be performed on the millimeter wave radar. The mutual complement process is not limited to the cancellation of clipping or the expansion of a detection area or scanning range, and can also be implemented by, for example, increasing the frame rate of the detection data output from the non-failing detectors 30.

### Other Embodiments

(1) In the foregoing embodiments, the front detector 30f, the central detector 30c, and the rear detector 30r positioned on the left side of the vehicle 50 are taken as an example. The present disclosure is similarly applicable to a plurality of detectors 30 on the front, right, or rear side of the vehicle 50. In addition, the overlapping detection area may be set in combinations such as the detectors on the front and left sides of the vehicle 50, the detectors on the front and right sides of the vehicle 50, the detectors on the rear and left sides of the vehicle 50, and the detectors on the rear and right sides of the vehicle 50.

(2) In the foregoing embodiments, the measurement device unit 10 is connected as the vehicle control device 40 to the driver assistance control device in the vehicle 50 as an example. The vehicle control device 40 is not limited to the driver assistance control device and may be any of various control devices such as a vehicle control device and a communication gateway control device in an in-vehicle network. In any case, it is possible to achieve an advantage of decreasing the number of cables from outside to inside the vehicle 50.

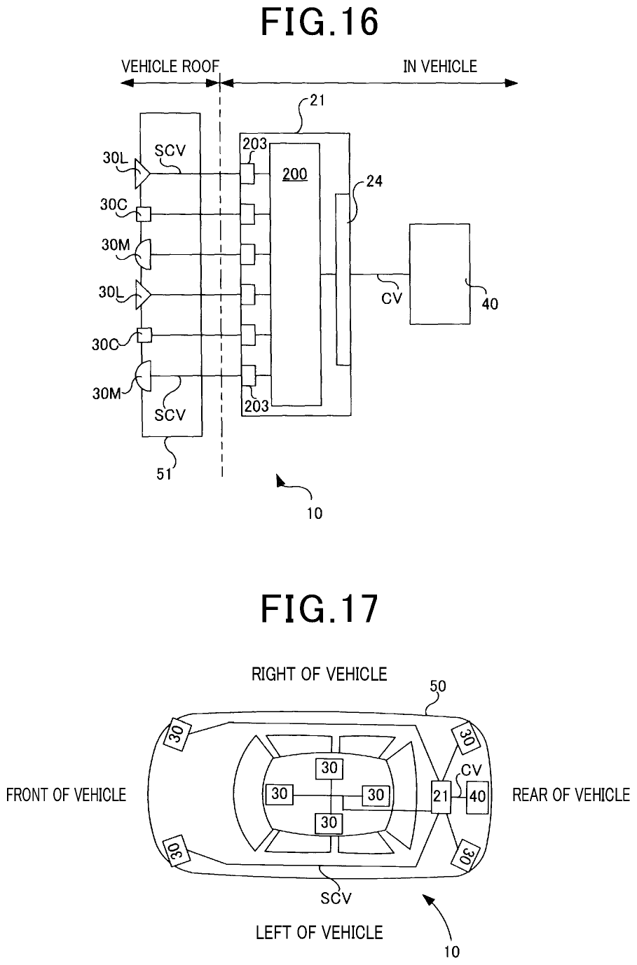

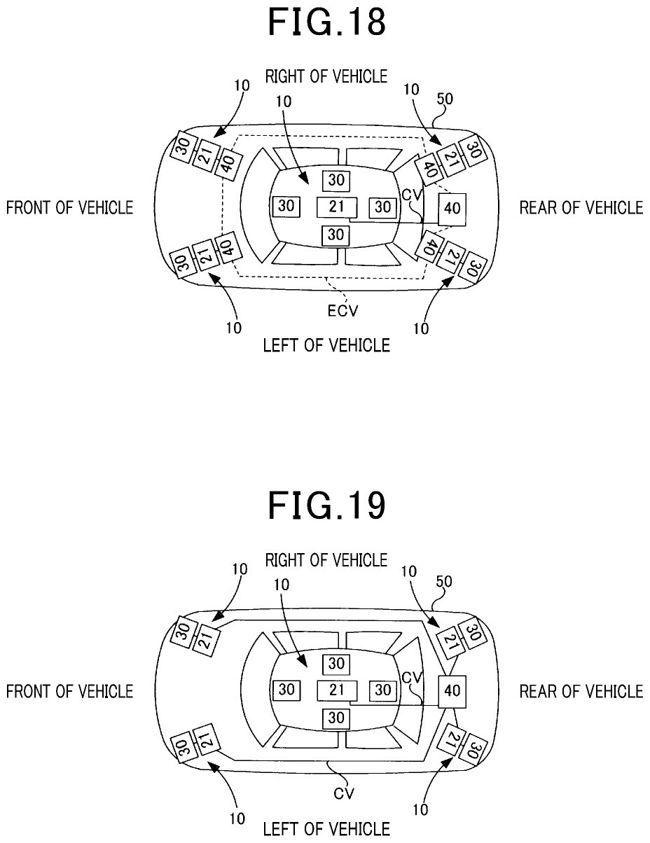

(3) In the foregoing embodiments, the measurement device unit 10 includes the data processing device 21 and the plurality of detectors 30, and the data processing device 21 is provided outside the vehicle 50. If the measurement device unit 10 only includes the data processing device 21, the data processing device 21 may be provided inside the vehicle 50 as illustrated in FIGS. 16 and 17. In the example of FIG. 17, detectors 30 are connected directly to a data processing device 21 inside a vehicle 50 via cables SCV. In this embodiment as well, the technically advantageous effects of the foregoing embodiments can be similarly obtained. That is, the integrated data generation process and the overlapping detection area setting process described above can be executed regardless of the physical installation position of the data processing device 21. Since the physical distance between the data processing device 21 and a vehicle control device 40 is short and a cable CV is routed inside the vehicle 50, it is possible to improve the noise immunity as compared to the case in which the data processing device 21 is provided outside the vehicle 50. Besides, as illustrated in FIGS. 18 and 19, a plurality of measurement device units 10 including a data processing device 21 and detectors 30 may be arranged in a vehicle 50. In the example of FIG. 18, the measurement device units 10 each include vehicle control devices 40. The plurality of vehicle control devices 40 is communicably connected to each other via cables ECV. In the example of FIG. 19, each vehicle control device 40 is provided for the corresponding one of the measurement device units 10. In these embodiments as well, the technically advantageous effects of the foregoing embodiments can be similarly obtained.

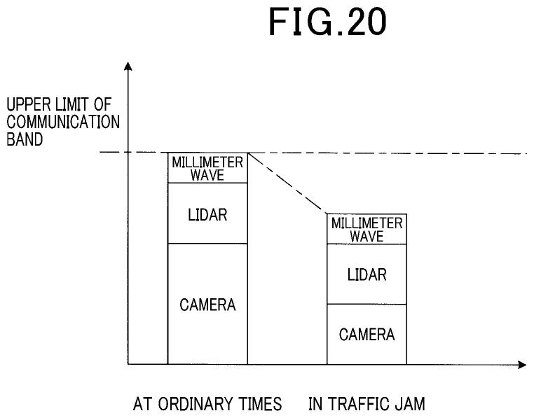

(4) In the foregoing embodiments, the allocation of data amount to the detectors 30 to constitute the integrated data are changed, that is, increased or decreased, during calibration or under fault condition of the detectors 30. The amount of data in the integrated data may be decreased in accordance with the running status of the vehicle 50. If the vehicle 50 gets caught in a traffic jam and runs at a low speed, for example, the amount of data from the cameras 30C may be decreased as illustrated in FIG. 20. In general, the amount of imaging data is large. If the amount of imaging data becomes small, that is, the imaging data is thinned out during low-speed running, the control of the vehicle 50, for example, the driver assistance for following the preceding vehicle can be provided using the results of detection by a lidar 30L or a millimeter wave radar 30M. The amount of data can be decreased by, for example, lowering the frame rate, expanding the clipping area in the detection area, narrowing down the scanning area, or increasing the amount of data to be thinned out by the data processing device 21. Decreasing the amount of data in the integrated data makes it possible to reduce the load of data processing on the subsequent processing device, for example, the vehicle control device 40, thereby suppressing power consumption. The detector 30 from which the amount of data is to be decreased in the integrated data is not limited to the camera 30C, and the amount of detection data from the lidar 30L or the millimeter wave radar 30M may be decreased, in accordance with the type of detection data required in the running status of the vehicle 50.

(5) In the foregoing embodiments, the integrated data generation process is performed by a pre-programmed integrated circuit such as an FPGA, ASIC, or SOC. Alternatively, the integrated data generation process may be performed software-wise by a CPU executing an integrated data generation program including a process of dynamically setting the overlapping detection area or may be performed hardware-wise by a discrete circuit. That is, the control unit and its control method in the foregoing embodiments may be implemented by a dedicated computer that includes a processor programmed to execute one or more functions concretized by a computer program and a memory. Alternatively, the control unit and its control method described in the present disclosure may be implemented by a dedicated computer that includes a processor formed of one or more dedicated hardware logic circuits. Otherwise, the control unit and its control method described in the present disclosure may be implemented by one or more dedicated computers that include a combination of a processor programmed to execute one or more functions and a memory and a processor including one or more hardware logic circuits. The computer program may be stored as instructions to be executed by a computer, in a computer-readable non-transient tangible recording medium.

The present disclosure has been described above based on embodiments and modifications, but the embodiments described above are provided in order to help understand the present disclosure and are not intended to limit the present disclosure. The present disclosure can be changed or improved without deviating from the gist of the present disclosure and the claims, and the present disclosure includes its equivalents. For example, technical features of embodiments and modifications corresponding to the technical features described in Summary of the Invention can be replaced or combined as appropriate to solve some or all of the issues described above or attain some or all of the advantageous effects described above. The technical features can also be deleted as appropriate unless they are described as essential herein.

What is claimed is:

1. A vehicle-mounted measurement device unit comprising a data processing device including:
a plurality of detector input units, each of which being connected to a corresponding one of a plurality of detectors having respective predetermined detection areas;
an output unit configured to be connected to a vehicle control device arranged in a vehicle;
an overlapping detection area setting unit configured to dynamically set an overlapping detection area between a plurality of arbitrary detectors among the plurality of detectors, for use during measurement and during non-measurement, or for use under normal conditions and under abnormal conditions; and
an integrated data generation unit configured to, in accordance with the set overlap detection area, generate integrated data using detection data corresponding to the detection areas input from the plurality of detectors via the plurality of detector input units and output the integrated data via the output unit.

2. The measurement device unit according to claim 1, wherein
the overlapping detection area setting unit is configured to:
set a measurement-time overlapping detection area for use during measurement; and
set a non-measurement-time overlapping detection area that is larger than the measurement-time overlapping detection area for use during diagnosis or calibration, and the integrated data generation unit is configured to:
achieve the measurement-time overlapping detection area by deleting detection data corresponding to at least part of the overlapping detection area from the detection data of at least one of the plurality of arbitrary adjacent detectors; and
achieve the non-measurement-time overlapping detection area by maintaining detection data corresponding to the overlapping detection area in the detection data from the plurality of arbitrary detectors.

3. The measurement device unit according to claim 1, wherein
the overlapping detection area setting unit is configured to:
set a measurement-time overlapping detection area for use during measurement; and
set a non-measurement-time overlapping detection area that is larger than the measurement-time overlapping detection area for use during diagnosis or calibration, and the integrated data generation unit is configured to:
during diagnosis or calibration, achieve the non-measurement-time overlapping detection area by expanding a physical detection area of at least one of the plurality of arbitrary detectors so as to be larger than the detection area during measurement.

4. The measurement device unit according to claim 1, wherein
a size of the overlapping detection area is specified by a communication band between the integrated data generation unit and the control device, and
the integrated data generation unit is configured to dynamically change a proportion of detection data from each of the plurality of arbitrary detectors in the integrated data, in accordance with the dynamically changed overlapping detection area.

5. The measurement device unit according to claim 2, wherein detection data corresponding to the non-measurement-time overlapping detection area among the detection data from the arbitrary detectors is used to execute diagnosis or calibration.

6. The measurement device unit according to claim 1, wherein
the overlapping detection area setting unit is configured to:
set a measurement-time overlapping detection area under normal conditions, and
set, under fault conditions where any one of the plurality of arbitrary detectors fails, a failing-time overlapping detection area by expanding the detection area of another detector among the plurality of arbitrary detectors to compensate for detection area of the determined failing detector, and
the integrated data generation unit is configured to:
achieve the measurement-time overlapping detection area by deleting normal-time clipping data from detection data from the plurality of arbitrary detectors, and
achieve the failing-time overlapping detection area by maintaining the normal-time clipping data in detection data from the plurality of arbitrary detectors.

7. The measurement device unit according to claim 1, further comprising the plurality of detectors having respective predetermined detection areas.

8. An integrated data generation method in a vehicle-mounted measurement device unit, comprising:
receiving detection data from a plurality of detectors having respective predetermined detection areas;
dynamically setting an overlapping detection area between a plurality of arbitrary detectors among the plurality of detectors, for use during measurement and during non-measurement, or for use under normal conditions and under abnormal conditions;
generating integrated data using detection data from the plurality of detectors in accordance with the set overlapping detection area; and
transmitting the integrated data to a control device arranged in a vehicle.
